(19) United States
(12) Patent Application Publication
(10) Pub. No.: US 2011/0108494 A1
(43) Pub. Date: May 12, 2011

(54) Carbon Dioxide Delivery System

(76) Inventor: Weston Whitaker, Oakland, CA (US)

(21) Appl. No.: 12/716,362

(22) Filed: Mar. 3, 2010

Related U.S. Application Data
(60) Provisional application No. 61/156,898, filed on Mar. 3, 2009.

(51) Int. Cl. C02F 1/68; A01K 63/04; B01D 19/00

(52) U.S. Cl. 210/750; 210/188; 210/167.21; 210/170.02; 210/170.01

(57) ABSTRACT

Included herein is a carbon dioxide delivery system. The system may include any of the following: (1) a body of a liquid; (2) a carbon dioxide recapture element in communication with the body; (3) a carbon dioxide generator in communication with the recapture element; and (4) a carbon dioxide effluent line exiting the generator and in communication with the body. Also included is a process of delivering carbon dioxide. The process includes capturing a first gas having a measurable amount of carbon dioxide from a body of liquid. The method also includes transmitting the first gas to a carbon dioxide generator and delivering a carbon dioxide enriched gas to the liquid.

### BACKGROUND

1. Field of Disclosure

Disclosed herein is a process for generating carbon dioxide and delivering it to an end use, in particular disclosed herein is an aerobic system for delivering carbon dioxide.

2. Prior Art

In the case of systems that benefit from the addition of carbon dioxide, such as planted aquariums, typical supplies of carbon dioxide include the addition of a compressed carbon dioxide system. However, such a system is very expensive and not conducive for cost sensitive applications.

A second option is an anaerobic fermentation system. A conventional anaerobic system uses the fermentation of yeast to generate carbon dioxide. An anaerobic system is typically less costly than a compressed carbon dioxide system. However, the anaerobic system generally requires that the yeast is replaced at least monthly, more typically about every other week. Unfortunately, anaerobic fermentation generates a by-product, ethanol, which inhibits future fermentation of the yeast to generate additional carbon dioxide.

### BRIEF DESCRIPTION

One embodiment disclosed herein includes a carbon dioxide delivery system. The system may include any of the following: (1) a body of a liquid; (2) a carbon dioxide recapture element in communication with the body; (3) a carbon dioxide generator in communication with the recapture element; and (4) a carbon dioxide effluent line exiting the generator and in communication with the body.

Also disclosed herein is a process of delivering carbon dioxide. The process includes capturing a first gas having a measurable amount of carbon dioxide from a body of liquid. The method also includes transmitting the first gas to a carbon dioxide generator and delivering a carbon dioxide enriched gas to the liquid.

Further disclosed here is an aquatic system. The system may include an aquarium and a carbon dioxide generator. The system further includes a generated carbon dioxide line in communication with the generator and the aquarium and an aquarium effluent in communication with the generator.

It is to be understood that both the foregoing brief description and the following detailed description provide embodiments which are intended to provide an overview or framework of understanding, the nature and character of the invention as it is claimed. The accompanying drawings are included to provide a further understanding of the invention and are incorporated in and constitute a part of the specification. The drawings illustrate various embodiments of the invention and together with the description serve to describe the principles and operations of the invention.

### DESCRIPTION OF THE DRAWING

FIG. 1 is a schematic view of an embodiment disclosed herein.

### DETAILED DESCRIPTION

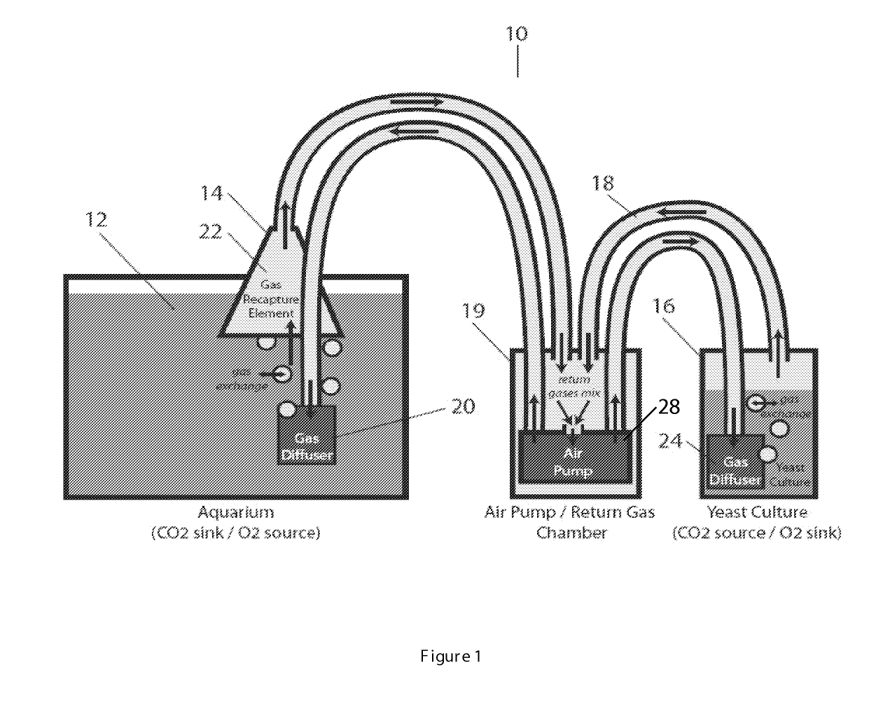

Illustrated in FIG. 1 is a carbon dioxide delivery system 10, preferably an aerobic system. The system may include a body of a liquid 12. The liquid may include water, salt or fresh water, a solvent, or a carrier material. Body 12 is not limited to any particular item. Some examples of body 12 include an aquarium, a shrimp farm, a fish pond, or a body of water used for agricultural purposes. In one particular embodiment, system 10 is an aquatic system in which body 12 is an aquarium. An example of a preferred aquarium is one that includes plant life.

System 10 may further include a gas diffusion and recapture element 14 in communication with body 12. As shown, element 14 includes an enclosure for directing recaptured carbon dioxide gas to an outlet line. During the period in which the carbon dioxide gas is in contact with body 12 and before leaving through element 14, carbon dioxide from the gas may be dissolved in body 12 while oxygen from body 12 may dissolve into the gas coming into body 12. Element 14 captures gas exiting body 12, preferably the exiting gas has a measurable amount of carbon dioxide and element 14 directs the gas towards a carbon dioxide generator 16. With respect to the gas in element 14 it is preferred that the gas includes more carbon dioxide than ambient air.

In one particular embodiment it is preferred that generator 16 is in communication with recapture element 14, meaning at least that a portion of gas in element 14 is delivered to generator 16. With respect to recapture element 14, as shown element 14 includes an enclosure 22 which at least a portion of enclosure 22 is disposed below a top surface of body 12. In another embodiment, enclosure 22 may be disposed above the top surface of body 12. In a further alternate embodiment, system 10 may be a closed system, meaning that it does not allow in ambient air. In one particular embodiment enclosure 22 comprises a funnel. Enclosure 22 is not limited to the funnel shown, in a further embodiment element 22 may comprise an apparatus which can capture gas exiting from body 12.

System 10 may further include a carbon dioxide effluent line 18 exiting generator 16 and in communication with body 12. Optionally system 10 may include an air in-take to bring ambient air into system 10. One example of the air in-take may include an air inlet valve on element 14. In a second example, the air in-take may be formed by capture element 14 being located above a top surface of body 12.

System 10 may also include a gas chamber 19. Gas chamber 19 may be in communication with at least one of body 12, generator 16, or both. As shown in FIG. 1, chamber 19 receives a gas from recapture element 14 and also receives a gas containing carbon dioxide generated in generator 16. It is further preferred that at least a significant portion of the gas from element 14 is directed to generator 16, preferably the majority of such gas, more preferably substantially all of such gas is directed to generator 16. Likewise, preferably, the carbon dioxide enriched gas from generator 16 is transferred from chamber 19 to body 12.

Additionally, body 12 may further include dissolving element 20 in communication with effluent line 18, thereby receiving carbon dioxide generated in generator 16. In one embodiment, element 20 comprise an air stone. Another example of dissolving element 20 may include a membrane. A third example of dissolving element 20 may include a tube. Other examples of element 20 include gravel or any other item that may be used or configured to break up bubbles of the carbon dioxide enriched gas as they enter into body 12 to increase the surface area of such gas.

In the case of an air stone, materials of construction of the air stone may include limewood or a porous stone. Alternatively, the air stone may be made from a synthetic material such as bonded glass beads or fiberglass.

In a further embodiment, generator 16 may include a dissolving element 24 in communication with the element 14, thereby receiving the gas having at least a measurable amount of a carbon dioxide leaving body 12 and being cycled to generator 16. Dissolving element 24 and dissolving element 20 may include the incorporation of a water pump to mix the gas and increase the period of time in which the gas remains in contact with body 12. Incorporation of a second air pump in element 20 or 24 may be used to further increase exchange between the gas and body 12. Additionally, element 14 or element 16 may contain long passages that increase the duration of contact between the gas and body 12 before leaving element 14. In one embodiment, the long passages may include internal ridges in element 14 which inhibit gas bubbles from freely flowing up element 14, thereby making the bubbles travel a longer distance and increasing a residence time which the bubbles are in contact with the liquid. In another embodiment, element 14 includes a diffusion element. The diffusion element creates a path in which the gas bubbles at least partially transverse one or more times across the width of the diffusion element while traveling along element 14. In a further embodiment, the diffusion element may increase the residence time gas bubbles are in contact with at least one of body 12 and element 14 prior to returning to generator 16.

Also disclosed herein is a process of operation of apparatus 10. In the process of delivering carbon dioxide, a first gas having a measurable amount of carbon dioxide is captured. As shown in FIG. 1, the gas is captured exiting from body 12. The process further includes transmitting the first gas to a carbon dioxide generator, such as the one illustrated as generator 16.

In generator 16, the first gas comes in contact with an environment which is generating further carbon dioxide, the environment includes a carbon dioxide precursor. The generated carbon dioxide enriches the first gas with additional carbon dioxide. The enriched gas is delivered to body 12. In one embodiment, carbon dioxide is generated in generator 16 by a fermentation process. In one specific embodiment, a yeast culture is used as the carbon dioxide precursor. In addition to the yeast, precursors may include a yeast energy source, yeast extract, yeast vitamins, a sugar, various carbohydrates or other types of organic compounds that can be fermented. Some examples of suitable sugars include sugar cane, corn syrup, malt, etc. Any of the various alternatives may be used in any combination thereof. In addition to the precursors, generator 16 may include nutrients for the precursor, buffers and/or supplements. In a particular embodiment, one or more of the carbon dioxide precursors and optionally one or more of the other materials may be included in an aqueous solution inside generator 16. Carbon dioxide generated in generator 16 may bubble through the aqueous solution and exit generator 16 through effluent line 18. Alternatively, carbon dioxide may be generated in generator 16 from a simple chemical reaction including a carbonate reaction in water. Compressed carbon dioxide may also be released in generator 16 as a means of enriching gas with carbon dioxide. In one particular embodiment, generator 16 may be referred to as a yeast respiration chamber.

The generation of carbon dioxide is not limited to the above techniques. Other techniques may be used to generate the carbon dioxide for system 10. Other examples include a chemical reaction (e.g., reacting acid and baking soda in water) or the carbon dioxide could even come from another aquarium that is missing plants so it has built up excess carbon dioxide. Preferably, generator 16 enriches the gas coming into generator 16 by having a liquid with an enriched amount of carbon dioxide the gas passes through the enriched liquid of carbon dioxide and at least a portion of the carbon dioxide in the liquid exits generator 16 in line 18.

Alternatively, another embodiment may be that generator 16 equilibrates gasses between two bodies of water. For example, if one body of water has high carbon dioxide and a low oxygen content (e.g. a yeast culture, or an aquarium with too many fish and no plants), and the other has low carbon dioxide and high oxygen (e.g. a planted aquarium), generator 16 may be used to regulate both in having intermediate levels of carbon dioxide and oxygen, thereby increasing the carbon dioxide content in the body having a low carbon dioxide content.

The process may also include the steps of dissolving the enriched gas. As shown in FIG. 1, the enriched gas is dissolved in body 12. As shown an air stone may be used to dissolve the enriched gas in body 12. However the disclosure is not limited to the use of an air stone as dissolving element 20.

An advantage of using dissolving element 20 is that the enriched gas is more easily diffused in body 12. In one particular embodiment of element 20, element 20 preferably functions to increase the surface area of enriched gas. This will inherently increase the time that the enriched gas is in contact with the liquid of body 12. One such technique is to break up large bubbles of enriched gas into smaller bubbles.

In addition to dissolving bubbles of enriched gas in body 12, bubbles of a first gas may be dissolved in generator 16. The same equipment as described above with respect to element 20 may be used as element 24. The same benefits of including element 20 would also be realized with respect to the use of element 24.

Furthermore, optionally system 10 may include a mixing chamber 19. In the embodiment shown in FIG. 1, the first gas passes through mixing chamber 19 and is pumped, by air pump 28, to generator 16. Also it is shown that the enriched gas passed through mixing chamber 19 and is pumped to body 12. As shown the first gas and the enriched gas pass each other in a concurrent flow pathway. However the disclosure is in no way limited to the use of mixing chamber 16 or the gases passing each other in concurrent flow.

In another embodiment, any one of the body 12, generator 16, and chamber 19, or any combination thereof, may include an agitation element such as a stir bar. Though such agitation is not required to practice what is disclosed herein.

With respect to transmitting the enriched carbon dioxide from generator 16 to body 12, in one embodiment, such gas may be transferred by a pressure differential between generator 16 and body 12 in terms of such gas transferring from a higher pressure environment, generator 16, to a lower pressure environment, body 12. In a second embodiment, such gas may be pumped from generator 16 to body 12. Additionally, in this embodiment, element 14 may transfer the gas directly to generator 16. In a third embodiment, which includes chamber 19, both of the pressure differential, pump(s), e.g. pumps 28, and combinations thereof may be used to transmit the carbon enriched gas from generator 16 to body 12. The above techniques may also be used to transfer the first gas from body 12 to generator 16, irrespective if system 10 includes chamber 19 or not.

As for the first gas, the first gas preferably includes at least a measureable amount of carbon dioxide. The gas may include other components also, such as air, nitrogen, oxygen, and other compounds and/or molecules that may be found in ambient air or water, and combinations thereof. With respect to the carbon dioxide enriched gas, preferably it includes at least a certain amount of the carbon dioxide generated in generator 16, more preferably, the enriched gas includes an increased concentration of carbon dioxide than the first gas. The enriched gas may include other components than carbon dioxide. Examples of such components are the components described above regarding the first gas.

One embodiment of system 10 includes recycling the carbon dioxide containing gas so that is can gradually build up to a higher level of carbon dioxide. The gas flow goes as follows: (a) gas enters the yeast culture in generator 16, exchanging oxygen for carbon dioxide; (b) carbon dioxide enriched gas flows out of generator 16 (due to pressure from (a)) and enters the mixing chamber 19; (c) while in chamber 19 carbon dioxide enriched gas mixes with return gas from body 12 and then enters pump 28; (d) gas from pump 28 is split between generator 16 and body 12; (e) gas that is pumped into body 12 forms small bubbles and exchanges carbon dioxide for oxygen; and (f) gas bubbles from body 12 caught by an enclosure are returned to chamber 19. Because the gas is being recaptured rather than just released in the aquarium, a high gas flow rate can be used to set up an equilibrium between the gases in generator 16 and body 12.

An advantage of the above embodiments include that the process disclosed generates minimal amounts of ethanol or other by-products which inhibit the production of carbon dioxide by inhibiting the metabolism of the carbon dioxide precursor, preferably, the above processes only generate trace amounts of ethanol or the like, more preferably insignificant amounts of ethanol, and even more preferred system 10 only generates traces amount of ethanol for a given period of operation. The afore is also an advantage for which the process disclosed herein has over known anaerobic systems which produce excess ethanol.

Another advantage of the process disclosed herein is that it may operate for more than a week without adding additional carbon dioxide precursor, preferably more than about four (4) weeks, more preferably about six (6) weeks or more, and even more preferably more than about eight (8) weeks.

A further advantage of an embodiment disclosed herein is that the embodiment uses aerobic respiration to generate the carbon dioxide. Additionally system 10 benefits from recycling gas having at least a trace amount of carbon dioxide back into generator 16.

A further advantage of the disclosed is that the respiration system disclosed produces three (3) times as much carbon dioxide per unit of glucose than an anaerobic fermentation process. An additional advantage of system 10 is that it may require only half as much yeast as conventional systems, preferably only a third of the yeast of a conventional system. For example if a conventional system uses a gallon of yeast, system 10 would only require a third of a gallon of yeast. As a result, system 10 has the advantage that generator 16 to generate carbon dioxide can be about half to about a third smaller than a carbon dioxide generator of conventional systems.

Conversely for the same amount of yeast as a conventional system, system 10 will produce an effective amount of carbon dioxide twice (2) as long as such conventional system, preferably at least about three (3) times as long.

As for a particular embodiment of aerobic respiration it has the following advantages over conventional anaerobic systems: (1) The ethanol that builds up and shuts down yeast activity during anaerobic fermentation will not be produced; (2) The yeast will produce three times as much carbon dioxide per unit of glucose; and (3) The yeast will be able to synthesize lipids essential for growth.

In addition to the above, system 10 has the advantage that the active gas diffusion taking place in body 12 before leaving enclosure 14 may be driven by a high flow rate gas pump configured such as element 28 rather than being restricted to only use of a water pump as currently available in active carbon dioxide diffusion systems.

A further advantage of one or more of the above embodiments, is that when element 14 is below a top surface of body 12 any carbon dioxide that is not dissolved into body 12 but is recaptured in element 14 it is not mixed with ambient air and in many cases is lost. Instead the recaptured carbon dioxide is cycled back to generator 16 and further processed back into body 12.

The disclosed system described above is also a low cost system.

The afore embodiments may be practiced in any combination thereof.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A carbon dioxide delivery system comprising:
a. A body of a liquid;
b. A carbon dioxide gas recapture element in communication with the body;
c. A carbon dioxide generator in communication with the recapture element; and
d. A carbon dioxide effluent line exiting the generator and in communication with the body.

2. The system of claim 1 wherein the liquid comprises at least one of water, a solvent, and combinations thereof.

3. The system of claim 1 wherein the body comprises one selected from an aquarium, a fish pond, a shrimp pond, a field of growing at least one agriculture product.

4. The system of claim 1 wherein the system includes an air in-take.

5. The system of claim 1 further including a gas chamber in communication with both the body of liquid and the generator.

6. The system of claim 1 wherein the body of liquid includes a dissolving element in communication with the effluent, thereby receiving carbon dioxide generated in the generator.

7. The system of claim 1 wherein the recapture element disposed below a top surface of the body of liquid.

8. The system of claim 1 wherein the generator includes a dissolving element in communication with the recapture element, thereby cycling carbon dioxide containing gas into the generator.

9. A process of delivering carbon dioxide comprising:
a. Capturing a first gas having a measurable amount of carbon dioxide from a body of liquid;
b. Transmitting the first gas to a carbon dioxide generator
c. Delivering a carbon dioxide enriched gas to the liquid.

10. The method of claim 9 further comprises generating carbon dioxide.

11. The method of claim 10 further comprises dissolving at least a portion of the carbon dioxide enriched gas in the body of liquid.

12. The method of claim 11 further comprises dissolving first gas in the generator.

13. The method of claim 9 passing the first gas and the carbon dioxide enriched gas through a mixing chamber.

14. An aquatic system comprising:
a. An aquarium;
b. A carbon dioxide generator;
c. A carbon dioxide generator line in communication with the generator and the aquarium; and
d. An aquarium effluent in communication with the generator.

15. The system of claim 14 wherein the aquarium having a dissolving element disposed in communication with the carbon dioxide generator line.

16. The system of claim 15 wherein the generator includes a dissolving element disposed in communication with the aquarium effluent.

17. The system of claim 15 wherein the dissolving element includes at least one air stone.

18. The system of claim 14 further comprising a mixing chamber disposed to communicate carbon dioxide generated from the generator to the aquarium.

19. The system of claim 14 wherein the system includes an in-take for ambient air.

20. The system of claim 14 wherein the aquarium and the effluent aligned to create an air in-take for the system.
